(19) United States
(12) Patent Application Publication
(10) Pub. No.: US 2009/0098282 A1
(43) Pub. Date: Apr. 16, 2009

(54) Wood floor refinishing and stain masking method

(75) Inventors: Daniel J. Prasalowicz, Brookhaven, PA (US); Leonard Villarose, JR., Clifton Heights, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Mr. SandlessTM Inc., Aston, PA (US)

(21) Appl. No.: 11/974,860

(22) Filed: Oct. 16, 2007

(51) Int. Cl. B05D 3/00

(52) U.S. Cl. 427/140

(57) ABSTRACT

A method that conceals finish penetrating stains in wood flooring without the need for replacing the boards or stripping and bleaching the stain is provided by applying a whitewash mixture while maintaining visibility of at least a portion of the wood grain, preparing a masking mixture from a selected color pigmented component similar to a non-damaged area of the finish and a carrier, applying a coat of the masking mixture to the effected area while maintaining visibility of the wood grain, and applying a finish/sealer to the effected area.

### FIELD OF INVENTION

The invention relates to refinishing of wood flooring, and in particular to a method for eliminating or masking finish penetrating stains, such as water stains, water marks, pet stains, or bacterial stains.

### BACKGROUND

A common problem in wood floors is finish penetrating stains, such as water stains, water marks, pet stains, or bacterial stains. For instance, if a pet should urinate on a carpet or area rug that sits on top of a wood floor, within 24 hours, a powerful bacteria forms. Bacteria needs three elements for growth: a warm, dark and moist environment. Because of the urine, these perfect conditions exist under the carpet or area rug for rapid growth. If not discovered and removed quickly, the bacteria will eat through the floor's finish and right into and through the board. If you turn a pet stained board over, the damage can be seen clear through to the other side. Sometimes the bacteria is so powerful, that it damages floors joists beneath the floor boards as well.

Flooring industry wide, the standard and traditional way to remove the stain would be to replace the damaged boards, which can range from $12 to $40 a linear foot—a very expensive solution. Alternatively, it may be possible to strip down the entire surface finish and soak the discolored areas with a saturate solution of oxalic acid crystals and warm water. This bleaching process removes the color from the wood, and re-finishing can then be carried out. However, using oxalic acid for stripping will not guarantee against reappearance of the stain especially if it is deep. Moreover, it is undesirable to use oxalic acid since it is toxic, combustible, caustic, corrosive, and contains Volatile Organic Compounds (VOCs) that are banned in certain countries.

It is desirable to provide an alternative to the prior known methods for treating finish penetrating stains that is less costly and not subject to reappearance of the stain, with the possibility of utilizing this alternative on both sanded and non-sanded refinishing processes for hardwood floors.

### SUMMARY

In accordance with the invention, a method is provided which conceals finish penetrating stains in wood flooring without the need for replacing or detaching the boards or stripping and bleaching the stain. The method includes:

Preparing a whitewash mixture from a white pigmented component and a carrier;

Applying the whitewash mixture at least to the effected area while maintaining visibility of at least a portion of the wood grain;

Preparing a masking mixture from a selected color pigmented component similar to a non-damaged area of the finish and a carrier;

Applying at least one coat of the masking mixture at least to the effected area, preferably maintaining visibility of at least a portion of the wood grain; and

Applying a finish/sealer at least to the effected area.

In another aspect, the invention provides a method for concealing any dark areas that remain in a floor after the first part of a no sanding wood floor refinishing process. The method is the same as the method noted above.

The method for masking finish penetrating stains during refinishing of hardwood floors in accordance with the invention can be used in conjunction with traditional sanding techniques as well, including light sanding, screen sanding, simple re-coats, and full sanding to hide and conceal any dark stain found in the floor after sanding, where board replacement or bleaching is not desired.

### BRIEF DESCRIPTION OF THE DRAWINGS

The present invention will be explained based on a presently preferred embodiment of the invention that is shown in the drawings and described in detail below.

The patent or application file contains at least one drawing executed in color. Copies of this patent or patent application publication with color drawings will be provided by the office upon request and payment of the necessary fee. In the drawings:

FIG. 1 is a flow diagram of the method in accordance with the present invention.

FIG. 2 is a color photographic Figure showing pet stain damaged areas in wood flooring prior to treatment in accordance with the present method.

FIG. 3 is a color photographic Figure showing the pet stain damaged areas in the wood flooring of FIG. 2 after light sanding.

FIG. 4 is a color photographic Figure showing the pet stain damaged area of the wood flooring of FIG. 3 after the application of a whitewash mixture.

FIG. 5 is a color photographic Figure showing the pet stain damaged areas in the wood flooring of FIG. 4 after a second coating of the whitewash mixture.

FIG. 6 is a color photographic Figure showing the pet stain damaged areas in the wood flooring of FIG. 5 after the application of several coats of a masking mixture.

FIG. 7 is a color photographic Figure showing the pet stain damaged areas in the wood flooring of FIG. 6 after the application of a finish/sealer.

FIG. 8 is a color photographic Figure showing pet stain damaged areas in wood flooring in a residence prior to treatment in accordance with the invention.

FIG. 9 is a color photographic Figure showing the pet stain damaged areas in the wood flooring of FIG. 8 after treatment in accordance with the present invention.

### DETAILED DESCRIPTION OF THE PREFERRED EMBODIMENT(S)

Certain terminology is used in the following description for convenience only and is not considered limiting. Words such as “top” and “bottom” designate directions in the drawings to which reference is made. This terminology includes the words specifically noted above, derivatives thereof and words of similar import. Additionally, the terms “a” and “one” are defined as including one or more of the referenced item unless specifically noted.

Wood flooring refers to any natural and engineered wooden boards used for interior flooring and stair threads. For purposes of describing the invention, the examples given is for pet stained wood flooring. However, the method described herein applies to removing or eliminating any finish penetrating stains.

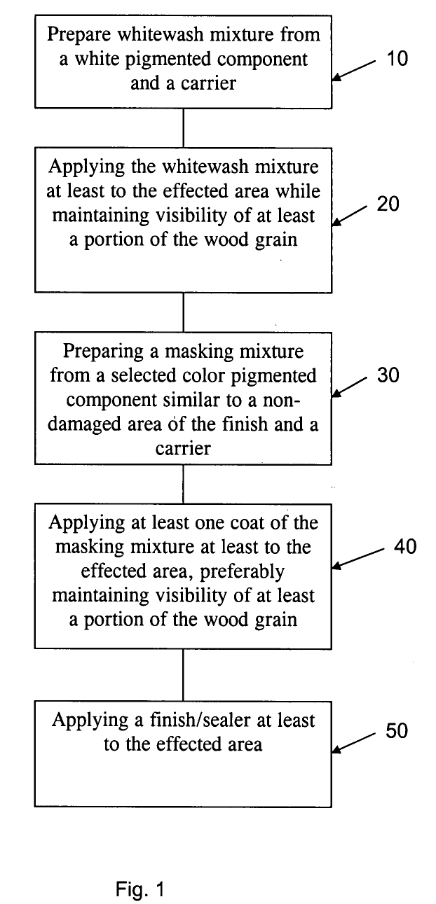

Referring to FIG. 1, a flow chart showing the method for masking pet stains in wood flooring is shown. In step 10, the first step is shown which requires preparing a whitewash mixture from a white pigmented component and a carrier. In the preferred embodiment, the whitewash mixture comprises a 1 to 1 ratio of a white pigmented component selected from the Group One list below and a carrier which comprises a finish or sealer coating selected from the Group Two list below.

Group One: Whitewash
Water-Based Wood Stain interior or exterior of any white shade no matter what that shade may be called, and any opacity of semi-solid, semi-transparent or solid.
Oil Based Wood Stain of any white shade no matter what that shade may be called and any opacity of semi-solid, semi-transparent or solid.
Oil Based Wood Finish of any white shade no matter what that shade may be called and any opacity of semi-solid, semi-transparent or solid.
Oil Based Gel Stains of any white shade no matter what that shade may be called and any opacity of semi-solid, semi-transparent or solid.
Oil Based Paint (Alkyd), interior or exterior of any white shade no matter what that shade may be called and any sheen of gloss, flat, matte, eggshell, satin, semi-gloss and high gloss.
Latex paint (Latex: Acrylic), interior or exterior of any white shade no matter what that shade may be called and any sheen of gloss, flat, matte, eggshell, satin, semi-gloss and high gloss.
Enamel paint of any white shade no matter what that shade may be called or any sheen of gloss, flat, matte, eggshell, satin, semi-gloss and high gloss.
Primer, interior or exterior of any white shade no matter what that shade may be called and any sheen of gloss, flat, matte, eggshell, satin, semi-gloss and high gloss.
Color tint or additives of any white shade no matter what that shade may be called.
One step stain and finish combination of any white shade no matter what that shade may be called.
Any type putty that is in a shade of white.

The shades of white that are considered to be “white” for the purposes of this invention include white, cream, cosmic latte, ivory, magnolia, Old lace, seashell and other primarily white colors.

Group Two: The Finish/Sealer Group
Clear Lacquer
Mr. Sandless™ high gloss wood floor finish
Oil-based polyurethane
Water based polyurethane
Minwax® brand Polycrylic®
Minwax® brand Helmsman® Spar Urethane
Minwax® brand Clear Shield
Epoxy Sealer
Shellac, with or without color
Varnish
Urethane
Acrylic
Acrylic polymers
Any catalyst created for sealing or finishing
Wood floor sealer, finish or coating
Mr. Sandless™ satin wood floor finish

Preferably, the white pigmented component and the carrier are combined at the 1 to 1 ratio, although a 1:2 or 2:1 ratio could be utilized, as desired. The components are preferably mixed, stirred or shaken until combined to form the whitewash mixture.

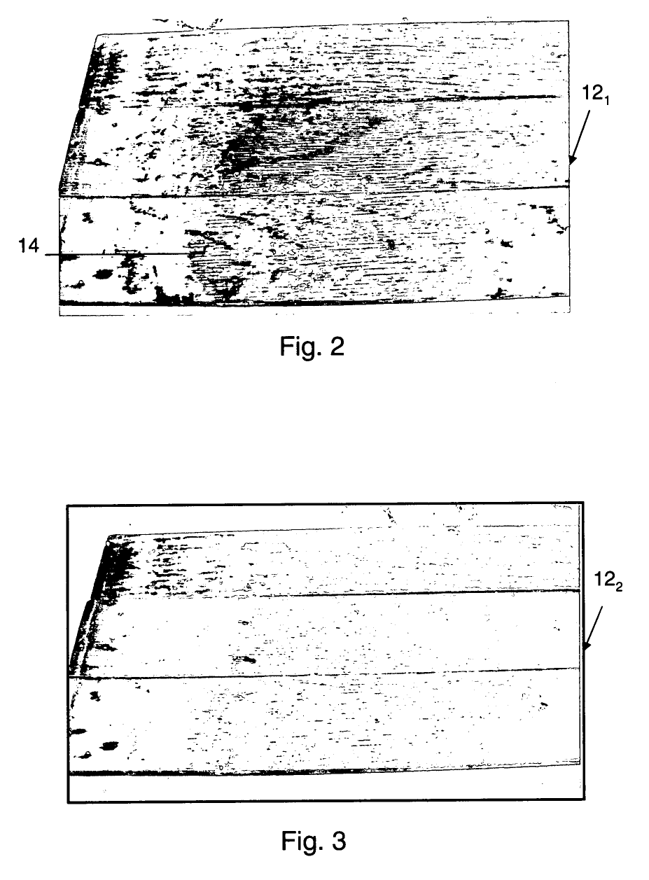

The boards shown in the FIGS. 2-7 are actual pet stained floor boards that were removed during a commercial repair and refinishing of flooring by the assignee of the present application, and which were treated using the present method, with the treatment steps being photographed to show the process. Although the floor boards were removed, one advantage of the present invention is that the method may be performed on an effected area in situ. This is particularly advantageous for an effected area on a stair thread or any other board where removal is costly and undesirable.

Referring to FIG. 2, actual floor boards 12₁ with a pet stain 14 are shown. Preferably, the effected area of the floor or boards 12₂ is at least lightly sanded as shown in FIG. 3. This can be done via an orbital sander or floor machine, preferably using 180 to 320 grit sandpaper, a sanding screen or the like. While this will lighten the pet stain initially as shown, the stain would reappear through a new finish applied to the floor if not treated in accordance with the present method.

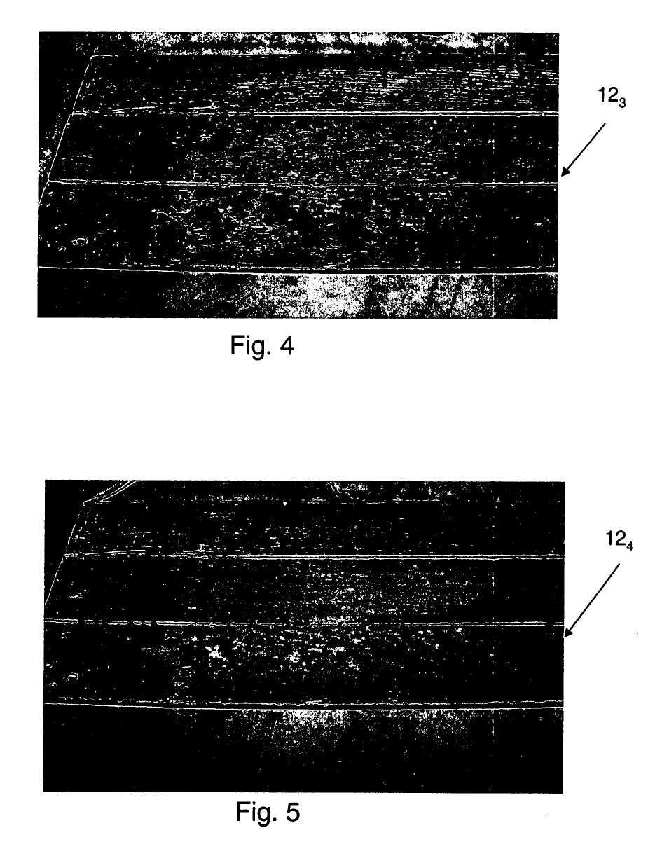

Referring to step 20 in FIG. 1, the method further includes applying the whitewash mixture at least to the effected area of the wood floor or boards while maintaining visibility of at least a portion of the wood grain, as shown in 12₃. The whitewash mixture is applied with a rag, brush, mop, a persons hand, sponge or any suitable application device to at least the effected area, heavy enough to cover the dark areas, but light enough to keep the grain visible. As shown in FIG. 4, where a first coat of white wash has been applied, the dark areas of the board 12₃ are covered or partially coated but that the grain is still visible. The grain is visible and remains since it runs deep into the board but the white pigment is applied to either penetrate or partially coat the surface for concealing the stain.

A second coat of the whitewash mixture can be applied after the first coat has dried, generally using the same technique. The sample 12₄ with the second coat of whitewash is shown in FIG. 5. Preferably between one and five coats of the whitewash mixture are applied in order to cover the pet stain. Generally, a user will continue coating the effected area with the whitewash mixture until the dark spots in the damaged area are no longer visible, but now appear white. If too many coats of the whitewash mixture are applied, the grains may disappear, and the floor will appear as if the damaged areas were painted rather than “masked.” While the desired condition is to keep as much of the wood grain visible as possible, if the grain pattern is lost, the result of the masking will still be much better after finishing than no masking at all.

Additionally, depending on the state of the effected area, no wood grain may be present even before the repair method is begun due to the high decomposition of the board.

Referring again to FIG. 1, the method further includes preparing a masking mixture from a selected color pigmented component similar to a non-damaged area of the finish and a carrier, as shown in step 30. In the preferred embodiment, a 1 to 1 ratio of a selected color pigmented or stain component selected from Group 3 below and the carrier selected from Group 4 below are combined.

Group Three:
Water-Based Wood Stain interior or exterior of any shade that matches the floor, and any opacity of semi-solid, semi-transparent or solid.
Oil Based Wood Stain of any shade that matches the floor, and any opacity of semi-solid, semi-transparent or solid.
Oil Based Wood Finish of any shade that matches the floor, and any opacity of semi-solid, semi-transparent or solid.
Oil Based Gel Stains of any shade that matches the floor, and any opacity of semi-solid, semi-transparent or solid.
Oil Based Paint (Alkyd), interior or exterior of any shade that matches the floor, and any sheen of gloss, flat, matte, eggshell, satin, semi-gloss and high gloss.
Latex paint (Latex: Acrylic), interior or exterior of any shade that matches the floor, and any sheen of gloss, flat, matte, eggshell, satin, semi-gloss and high gloss.
Enamel paint of any shade that matches the floor, or any sheen of gloss, flat, matte, eggshell, satin, semi-gloss and high gloss.
Primer, interior or exterior of any shade that matches the floor, and any sheen of gloss, flat, matte, eggshell, satin, semi-gloss and high gloss.
Color tint or additives of any shade that matches the floor.
One step stain and finish combination of any shade that matches the floor.
Any type of putty available in any shade.
Mr. Sandless™ satin wood floor finish.

The objective for Group 3 is to match the stain or pigment color to the finish that is being matched in the surrounding undamaged boards of the floor or boards. There is no specific formula for matching color as this depends on the particular job site. However, those skilled in the art will readily understand that commercially available stains and/or pigments can be used directly or mixed and blended as desired to approximate the desired color.

Group Four: The Finish/Sealer Group
Clear Lacquer
Mr. Sandless™ high gloss wood floor finish
Oil-based polyurethane
Water based polyurethane
Minwax® brand Polycrylic®
Minwax® brand Helmsman® Spar Urethane
Minwax® brand Clear Shield
Epoxy Sealer
Shellac, with or without color
Varnish
Urethane
Acrylic
Acrylic polymers
Any catalyst created for sealing or finishing
Wood floor sealer, finish or coating

The Group 3 and Group 4 components are selected and mixed together using any suitable mixing method, such as mixing, shaking or stirring in order to combine the components in order to form the masking mixture. While a 1:1 ratio of the Group 3 to Group 4 components is preferred, this ratio can be varied, for example from a ratio of 1:2 to 2:1.

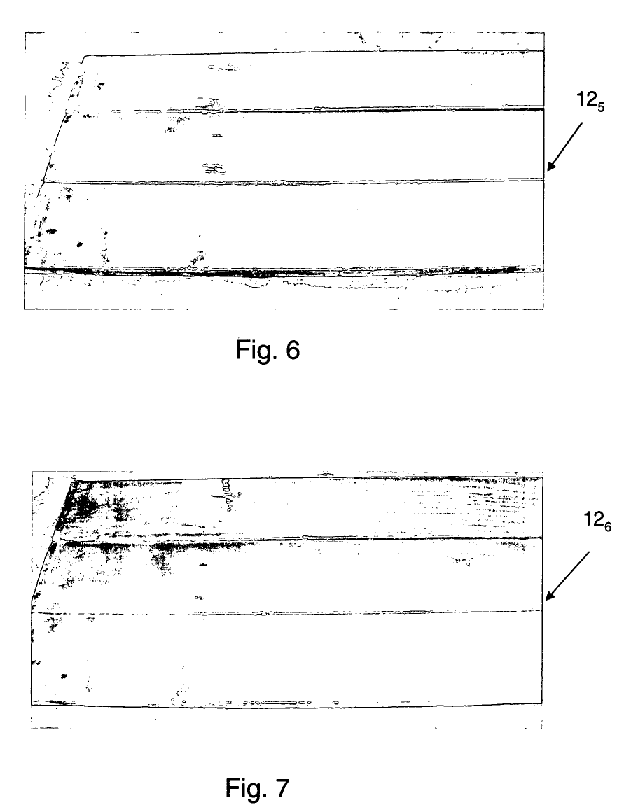

The masking mixture is then applied using a rag, brush, mop, sponge or any suitable applicator, as shown in step 40 of FIG. 1. The masking mixture is applied to the effected area on board 12₅, heavy enough to cover the dark areas, but light enough so that at least some of the wood grain remains visible, as shown in FIG. 6. The goal is to provide a matching color in the treated area of the boards, effectively “masking” the pet stain. Again, the idea is to get the color into the boards 12, while to the extent possible, keeping the grain of the wood visible. Preferably, some of the grain should remain visible. However, depending on the level of damage and the color, it is possible that the grain could be partially or wholly obscured. However, this can still provide an acceptable result given the color matching provided by the masking mixture.

In the example shown in FIG. 6, an “English Oak” water based wood stain was used combined with Mr. Sandless™ high gloss wood floor finish that is an acrylic-water based finish. The boards were coated four times with the mask mixture and the wood grain is still partially visible. It is also possible, if desired to add false graining back to the boards 12, if desired, using a graining pen or other false graining techniques.

Finally, as shown in FIG. 1, step 50, in order to achieve a better overall tone on these particular boards, the boards should be sealed with one or two top coats of any sealer or finish from the following Finish/Sealer group:

Group Five: Finish/Sealer Group
Mr. Sandless™ Wood Floor Finish, satin or high gloss
Clear Lacquer
Oil-based polyurethane
Water based polyurethane
Minwax® brand Polycrylic®
Minwax® brand Helmsman® Spar Urethane
Minwax® brand Clear Shield
Epoxy Sealer
Shellac, with or without color
Varnish
Urethane
Acrylic
Acrylic polymers
Any catalyst created for sealing or finishing
Wood floor sealer, finish or coating

In FIG. 7, Amber Shellac was used as the final sealer and applied in very light coats to board 12₆. However, any of the finish/sealers noted could be utilized, as well as other suitable floor coating finishes.

In FIGS. 2-7, all 3 boards are shown on an angle in color so that the transformation can be seen. This shows what otherwise would have been a resurfacing dark spot, if untreated.

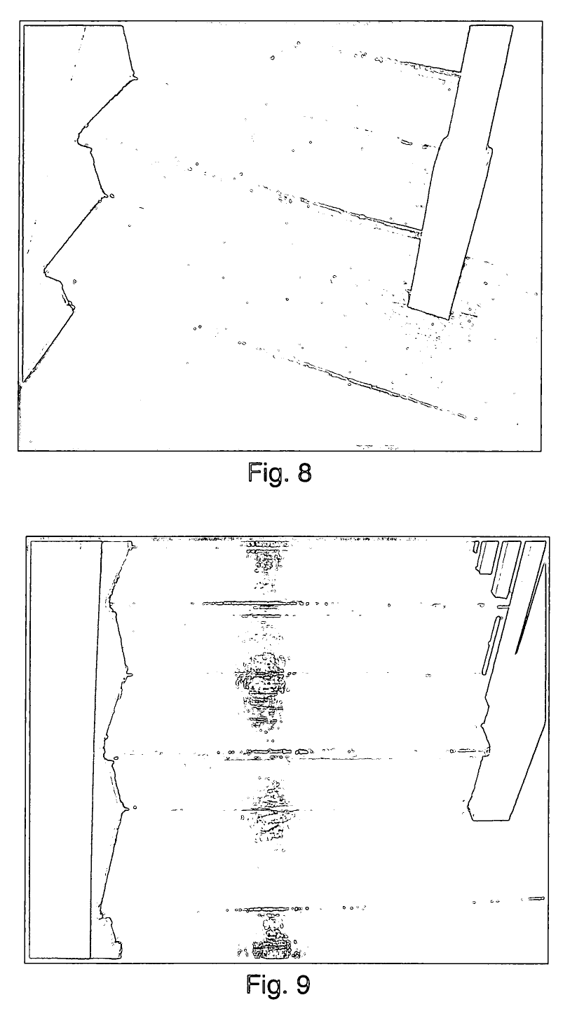

Referring to FIGS. 8 and 9, before and after photographs of boards 12₁-12₆ treated in situ are shown. In FIG. 8, the pet stain that was trapped under carpet as shown. In FIG. 9, after treatment in accordance with the process shown in FIG. 1 and described in detail above, the pet stain is masked without the cost and expense associated with replacing boards, which can be particularly costly on stair treads.

While the present invention has been described with respect to the specific examples shown, those skilled in the art of wood floor maintenance and repair will understand the scope and applicability of the present invention and the costs that can be saved in not having to replace boards when encountering finish penetrating stains.

1. A method to conceal stain damage in an effected area of wood flooring, comprising:
preparing a whitewash mixture from a white pigmented component and a first finish or sealer;
applying the whitewash mixture at least to the effected area while maintaining visibility of at least a portion of the wood grain;
preparing a masking mixture from a selected color pigmented component similar to a non-damaged finish area and a carrier;
applying at least one coat of the masking mixture at least to the effected area; and
applying a second finish or sealer at least to the effected area.

2. The method of claim 1, further comprising:
maintaining visibility of at least a portion of the wood grain during application of the masking mixture.

3. The method of claim 1, further comprising:
applying multiple coats of the whitewash mixture.

4. The method of claim 1, further comprising:
applying multiple coats of the masking mixture.

5. The method of claim 1, further comprising:
applying multiple coats of the second finish or sealer.

6. The method of claim 1, wherein the whitewash mixture is formed from a ratio of 1:2 to 2:1 of the white pigmented component and the first finish or sealer.

7. The method of claim 1, wherein the whitewash masking mixture is formed from a ratio of 1:2 to 2:1 of the selected color pigmented component and the carrier.

8. The method of claim 1, wherein the method is performed on the effected area in situ.

9. The method of claim 1, wherein the whitewash mixture is applied so that it partially coats the surface of the effected area of the wood flooring.

10. The method of claim 1, wherein at least part of the stain damage in the effected area of wood flooring remains subsequent to applying the whitewash mixture.
